(19) United States
(12) Patent Application Publication
(10) Pub. No.: US 2006/0069564 A1
(43) Pub. Date: Mar. 30, 2006

(54) METHOD OF WEIGHTING SPEECH RECOGNITION GRAMMAR RESPONSES USING KNOWLEDGE BASE USAGE DATA

(75) Inventors: Dana H. Allison, Lima, NY (US); Anthony Solpietro, Rochester, NY (US)

Correspondence Address: BLACKWELL SANDERS PEPER MARTIN LLP, 4801 Main Street, Suite 1000, KANSAS CITY, MO, 64112, US

(73) Assignee: RIGHTNOW TECHNOLOGIES, INC., Bozeman, MT (US)

(21) Appl. No.: 11/162,420

(22) Filed: Sep. 9, 2005

Related U.S. Application Data
(60) Provisional application No. 60/609,072, filed on Sep. 10, 2004.

(51) Int. Cl. G10L 15/18

(52) U.S. Cl. 704/257

(57) ABSTRACT

A method of speech recognition is provided for use in searching a knowledge database. A spoken command is communicated to a system. The spoken command is responded to with a set comprising a plurality of keywords. The plurality of keywords is arranged in a best possible set of matches which set of matches is derived by mathematically combining a speech recognition confidence score and a keyword weighting score. The best possible set of matches is then provided to the user.

### CROSS-REFERENCE TO RELATED APPLICATIONS

This application is a Non-Provisional application based on Provisional Application Ser. No. 60/609,072, Filed Sep. 10, 2004 for a METHOD OF WEIGHTING SPEECH RECOGNITION GRAMMAR RESPONSES USING KNOWLEDGE BASE USAGE DATA

The entire disclosure of the just referenced provisional patent application is incorporated herein by reference.

### TECHNICAL AREA OF THE INVENTION

The present invention relates generally to a method of speech recognition, and more particularly, to such a method as applied to searching a knowledge database.

### BACKGROUND

In an increasingly competitive marketplace, businesses are continually searching for methods of reducing expenses while maintaining, or possibly increasing the level of services they provide their customers. Self service applications are often employed to satisfy the above criteria. Businesses that already provide some degree of customer support could use self service applications to expand their service, while fledgling businesses may consider providing customer support when it was initially not feasible.

In addition to being a significant tool for customer service based organizations, speech recognition systems also serve to reduce costs and furnish competitive advantages for a wide variety of businesses, ranging from pharmaceutical and healthcare organizations to the financial service industry. Generally, most businesses find the pay back on investment for a speech recognition system may be less than a year.

While various other forms of self-service automation, such as touch-tone systems, are known, speech recognition is the option that most customers prefer. Additionally, because it requires no more than speaking into a phone, this option is accessible by most consumers.

Generally, speech recognizing systems receive a spoken word, or set of spoken words, and return a list of possible search recognition results. The results are referred to as the “n-th best” list, and a confidence score is applied to each of the provided results. Variables influencing there results include weighting factors specified in the grammar or through post processing the results. The system then utilizes these results to decide the most suitable course of action. Many times the confidence levels of the results ascertained by the system are fairly close, and require an additional means for prioritizing one particular result before another. In such instances a weighting factor is applied by the grammar designer. Preferably the weighting factor is application specific and serves to prioritize the more likely members of the set of results. [User interfaces having speech recognition capabilities are known. On such system isdisclosed in U.S. Pat. No. 6,434,524 entitled Object Interactive User InterfaceUsing Speech Recognition and Natural Language Processing. The reference discloses a system and method wherein utterances are used to establish interactions with objects. The system encompasses both speech processing and natural language processing. In operation a speech processor searches a first grammar file for a matching phrase for the utterance. If the matching phrase is not found in the first grammar file then a second grammar file is searched. The natural language processor searches a database for a matching entry assigned to the matching phrase. Upon finding the matching entry, an application interface serves to perform the action that is associated with said entry. The speech recognition and natural language processing efficiency are optimized by utilizing user voice profiles, that can be updated for individual users.

While having individual user voice profiles enables the system to enhance the reliability of speech recognition processing such an approach is not practical for larger systems serving to provide a platform for a greater number of users. Generally, the storage capabilities and system maintenance necessary to sustain such an operation is too costly and time consuming to be practical. Furthermore, such a system is time consuming and ineffective for consumer use.

Searchable knowledge bases are known to accept text keywords from users, to thereby search for items stored in said bases. Methods exist for returning results influenced by accumulated search activity of various channels and sources, thereby allowing the results of the search to adapt to changes in the products and services being offered, as well as the resulting questions they generate from the customer base. For example, a list of frequently asked questions may be returned from the query wherein the most likely desired response (or most requested) is listed first and other likely responses may be displayed as well.

One such searchable database is disclosed in U.S. Pat. No. 6,415,281 issued to Anderson. The Anderson patent discloses a system and method for arranging records in search result in response to a data inquiry of a database. The results of the search are arranged in an order based on various factors such as the destination of the search results, the preferred status of certain records over other records, a marketing determination with respect to the records, a frequency determination with respect to the number of times that a record or records may have already been provided in response to data inquiries, a weighting factor determination or a combination of one or more of these factors. In response to the determination of the order of the records in the search results, the records then are arranged into ordered records based on the determination. This order may be an alphabetical order, a preferred order based on the preferred status of certain records over other records, a least frequent first order, a highest weighting factor first order, or a combination of these orders. The search results with the records arranged into ordered records are then provided in response to the data inquiry.

While the aforementioned disclosure discusses a wide variety of factors used to determine the order in which search results are presented, it should be noted there is high degree of certainty that the text data inquiry received by the database is an accurate representation of the word or phrase as intended to be entered by the user. In the arena of speech recognition the degree of certainty is considerably lower, therefore the criteria outlined in the disclosure above would not be adequate for optimizing the matches for a speech searchable database.

Therefore, what is needed in the art is a method of speech recognition having optimized recognition performance, and capable of serving a large number of users.

Furthermore, what is needed in the art is a method of speech recognition capable of searching a knowledge database and retrieving an optimized set of match possibilities.

### SUMMARY OF THE INVENTION

The present invention provides a novel and improved method of speech recognition for searching a knowledge database and retrieving an optimized set of match possibilities. The present invention comprises in one form thereof a method of speech recognition for searching a knowledge database, accomplished by assigning a weighted score to entries in the grammar. The weighted score is based on prior searches conducted in the knowledge database wherein more frequently requested keywords in the grammar are assigned a greater weight. The method then serves to mathematically combine the speech recognition confidence scores and the aforementioned keyword weighting score as derived from the knowledge data base, thereby providing an optimized set of keywords for searching the knowledge database. This method leverages the bases 'ability to effect recognition performance.

An advantage of the present invention is an improved confidence level for the keywords entered in the grammar, based upon the frequency of words searched.

Another advantage of the present invention is that any new keywords, not appearing in the grammar may be reviewed and added to the grammar if appropriate.

### BRIEF DESCRIPTION OF THE DRAWINGS

The above-mentioned and other features and advantages of this invention, and the mariner of attaining them, will become apparent and be more completely understood by reference to the following description of an embodiment of the invention when read in conjunction with the accompanying drawing, wherein:

FIG. 1 is a representation of a multi-tiered interactive speech recognition platform utilized in the present invention.

Corresponding reference characters indicate corresponding parts from the view. The exemplification set out herein illustrates one embodiment, in one form, and such exemplification is not to be construed as limiting the scope of the invention in any manner.

### DETAILED DESCRIPTION

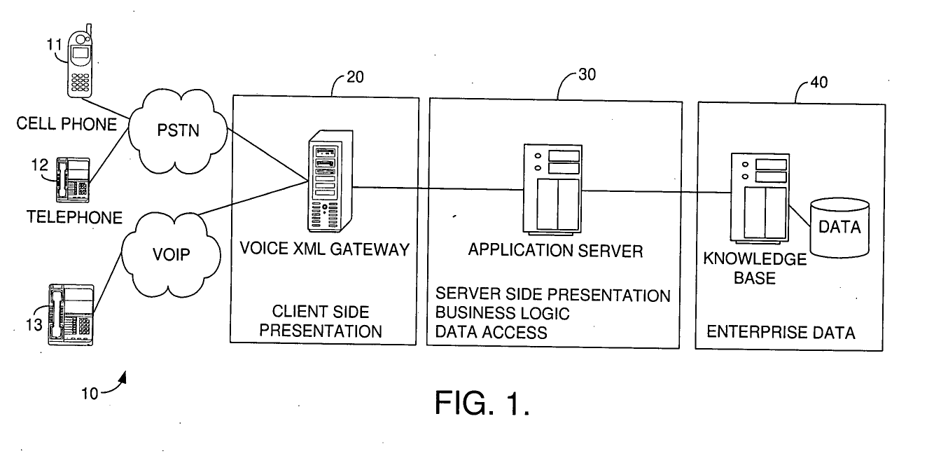

Referring to the drawings, and particularly to FIG. 1, a typical multi-tiered interactive speech recognition platform, similar to that utilized in the present invention is shown. The system was designed to operate on, and be compatible with, standard hardware and software platforms utilizing web based standards and protocols.

Generally, a caller queries the system via an input communication device 10 such as, for example, a cell phone 11 or a standard telephone 12 by issuing a verbal command. The verbal commands issued by a caller are transmitted to the system via either a PSTN (Public switched telephone network), VOIP (voice over internet protocol 13), or any other suitable means. These verbal commands are received in the system by the VoiceXML gateway 20. Generally VoiceXML serves multiple speech applications, including speech recognition. The Voice XML interpreter, operates in a similar manner to a web browser, in that it serves to issue HTTP (Hypertext Transfer Protocol) requests responsive to its interpretation of the speech commands received.

The next stage of the platform, hereby referred to as the Application Server 30, generally includes three segments or tiers, namely the Server Side Presentation Segment, the Business Logic Segment, and the Data Access Segment. The server side presentation segment utilizes Java Server Pages (JSP) and Java Servlet technology to dynamically generate VoiceXML documents in response to the HTTP requests from the VoiceXML Gateway 20. JAVA classes are used to implement the specified business logic. Furthermore, the Business Logic Segment, or tier, serves as an intermediary with the Data Access Segment, wherein the knowledge base is accessed and the Server Side Presentation segment wherein dialog with the user is received and transmitted. Finally, the Data (knowledge) Base Segment 40 communicates with the aforementioned data access tier using standard database technology and protocols, such as, for example, JDBC and XML. The method of the present invention can be used to optimize speech recognition when utilized in systems such as for example the system defined above, however the method of the present invention is capable of being utilized on all speech recognition systems, wherein searches are performed in knowledge databases.

The speech recognition system of the present invention analyzes speech samples, and generates a list of possible words or phrases that the speaker may have intended. In the present invention a user calls or connects to a speech recognition system to request assistance. At some point after connection, the user will be prompted to either state a keyword of his choosing, or to select from a number of keywords suggested to the user by the system. The user's spoken keywords are then transformed via a transforming means, such as the VoiceXML segment outlined above, into a form or keyword that is recognizable to a database, and generate a list of keywords. The generated list of keywords is commonly referred to as the n-th best list. Furthermore, for each of the keywords returned on the n-th best list, a confidence score is assigned, wherein a number of factors specified in the grammars or post processing serve to determine the order of the list. The method of the present invention serves to optimize the order of the n-th best list, thereby providing a more accurate response to the user's query. The method includes mathematically combining the speech recognition confidence scores and the keyword weighting score as derived from the knowledge data base, thereby providing an optimized set of keywords for searching the knowledge database leveraging the bases' ability to effect recognition performance.

Furthermore, the present invention provides a method for providing an optimized set of keywords in response to a spoken command. In the present invention, reports are generated providing an ordered list of key words used to search the knowledge base along with their respective frequency counts. Keywords submitted by the user that are not currently in the grammar are evaluated and added if appropriate. A weighting factor is assigned to each keyword, wherein the weighting factor for each keyword in the grammar is updated based on its frequency count. The formula used to calculate the weighting factors as well as the frequency updates is at the discretion of the grammar designer. The updated grammar is then deployed for the application to use, thereby serving to provide an n-th best list. When a grammar does not support a weighting factor, the application can use a parallel grammar with weighting factors to post process recognition results.

In operation, the present invention entails periodically generating reports containing keywords used to search the knowledge base, along with their respective frequency counts. These reports will allow designers to review and evaluate new keywords spoken by users, which are not currently included in the grammar. Upon evaluation, the designers may choose to add such new keywords to the grammar if deemed appropriate. Additionally, the reports provide a means for the designers to evaluate the current grammar allowing them to update the weighting factor and frequency counts of each keyword in the grammar based on the frequency count. The reports further include the number of times that these keywords are requested. Finally, the updated grammar is installed in the application for use.

While this invention has been described as having a particular embodiment, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having ”and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of speech recognition for optimizing a set of keywords presented to a user, selected from a plurality of keywords in a knowledge database, said method comprising the steps of:
receiving at least one spoken command from a user via a communication means;
responding to said at least one spoken command with a set comprising of a plurality of keywords;
arranging said set of said plurality of keywords in order of the best possible set of matches, wherein said order of the best possible matches of said plurality of keywords is derived by mathematically combining a speech recognition confidence score and a keyword weighting score derived from the knowledge base; and
providing said best possible set of matches selected from said set of said plurality of keywords to said user.

2. The method of speech recognition of claim 1 wherein said keyword weighting score is derived from the frequency of keyword searches in the knowledge base.

3. The method of speech recognition of claim 1 further comprising the steps of;
generating order lists of keywords along with their respective frequency counts; adding new keywords to the list of grammar if appropriate; and
adjusting the weighting factor of the keywords based on their respective frequency counts.

4. A method of speech recognition for presenting an optimized set of keywords selected from a plurality of keywords for searching a knowledge database comprising the steps of:
receiving at least one spoken command;
applying a weighted score to a plurality of keywords in said database;
applying a speech recognition confidence score for said at least one spoken word from said caller;
combining said weighted score from said plurality of keywords in said database and said weighted confidence score for said at least one spoken command from said caller; and
providing said caller with the optimal set of keywords based on the above criteria.

5. The method of speech recognition of claim 4 wherein said weighted score of said keywords is based on the frequency of the selection of said keywords.

6. The method of speech recognition of claim 4 wherein a keyword entered by a user, which is not found in the knowledge database is evaluated based on frequency of requests, and added to said knowledge database.

7. The method of speech recognition of claim 4 wherein said speech recognition confidence scores for said at least one spoken word from said caller is arrived at from an ordered list of speech recognition results.

8. An apparatus for receiving a spoken keyword from a user and providing said user an optimized set of keywords based on said spoken keyword comprising:
a means for receiving said spoken keyword from said user;
a means for converting said spoken keyword into a format capable of searching a knowledge database;
a means for compiling and reporting the frequency of searches for each of said keywords; an application server having a means for weighting the keywords based on said frequency of searches for each of said keywords and arranging a set of keywords in an order wherein said weighting of said keywords is a factor; and
a means for transmitting said set of keywords to said user.
